(19) United States
(12) Patent Application Publication
(10) Pub. No.: US 2026/0109861 A1
(43) Pub. Date: Apr. 23, 2026

(54) METHOD FOR MANUFACTURING CONSTRUCTION PARTS FROM RECYCLED RESIDUAL BITUMINOUS MATERIAL AND RECYCLED POLYETHYLENE

(71) Applicant: Katevara OÜ, Jõhvi (EE)

(72) Inventor: Jüri LIIV, Tartu maakond (EE)

(73) Assignee: Katevara OÜ, Jõhvi (EE)

(21) Appl. No.: 19/351,617

(22) Filed: Oct. 7, 2025

(30) Foreign Application Priority Data
Oct. 21, 2024 (EE) U202400030

(51) Int. Cl. C08L 95/00; B29B 17/04; B29K 23/00; B29K 105/26

(52) U.S. Cl. CPC C08L 95/00; B29B 17/0412; B29K 2023/0633; B29K 2023/065; B29K 2105/26; C08L 2207/062; C08L 2207/066; C08L 2207/22

(57) ABSTRACT

The present invention provides method for manufacturing construction parts from recycled residual bitumen material and recycled polyethylene. The cleaned and shredded residual bituminous material, which is bitumen-containing roofing material, is mixed with shredded recycled polyethylene in a heated mixer. Stabilizers and fillers are added to the mixture. Construction parts are made from the resulting mixture by pressing or molding.

### CROSS-REFERENCE

This application claims priority to Estonian Application No. U202400030 filed on Oct. 21, 2024. The content of this application is incorporated herein by reference in its entirety.

### TECHNICAL FIELD

The present invention belongs to the field of manufacture of construction materials and relates to a method for manufacturing construction parts from residual bituminous material, comprising residual bitumen, recycled bitumen-based roofing materials (BBRM), and recycled polyethylene, whereby the method is suitable for use in the construction of buildings as well as other structures, especially for manufacturing roof details, passageways and waterproofing elements.

### BACKGROUND ART

Bitumen is widely used in construction as a waterproofing and binding material in road covers, due to its bonding properties and watertightness. However, at low temperatures, bitumen may become brittle, and at high temperatures it may become too soft, which limits its usage possibilities.

Bitumen-based roofing materials (BBRM) are used widely in construction industry due to their durability, weather resistance and flexibility. These are available in two forms: modified bitumen roofing (MBR) membranes and built-up roofing (BUR) materials.

An example of such materials is so-called tar paper (roofing felt), which is actually a construction material for roof, impregnated with bitumen. In other words, this is a roll material for roofing and waterproofing, made by covering a board impregnated with oil bitumen with modified bitumen and/or bulk materials.

MBR is comprised of a bitumen base, mixed with synthetic rubbers or plastics, such as SBS (styrene-butadiene-styrene) or APP (atactic polypropylene).

Recycling of bitumen-based roofing materials is becoming increasingly more important, as the construction industry is moving towards sustainability. Unfortunately, the available recycling methods are rather limited: old roofing materials can be shredded and mixed with asphalt for covering roads, or combusted into energy. Polyethylene is a polymer, which is known for its flexibility, strength, and resistance to various chemicals.

Used plastics can be shredded and reformed into new products. However, during recycling the quality of material deteriorates due to heat. The present method aims to overcome the limitations to the reuse of clean BBRM, by combining it with the co-polymerization process of polyethylene. The resulting composite material combines favorable properties of each individual component, creating a product which is more versatile and durable than bitumen alone.

### DISCLOSURE OF THE INVENTION

The present invention relates to a method, where residual bituminous material, such as residual bitumen and roofing material based on recycled bitumen, and recycled polyethylene are mixed and processed, in order to create a new construction material, which is durable, environment-friendly and economical. The method enables to recycle the waste generated during demolition of roof and industrial waste, and to minimize environmental impacts, while providing high-quality construction parts resistant to outdoor conditions. The present invention enables to minimize essentially disposal and combustion of the said materials.

The main objective of the invention is to propose a method that enables to manufacture high-quality construction materials, using residual bituminous material, such as residual bitumen, bitumen-based roofing material, and recycled polyethylene, which would usually be treated as waste.

Upon periodical covering of roof, it is covered with a bitumen layer, onto which a new cover material is installed. In the course of time, a thick layer of such materials will form, which is removed upon complete renovation or demolition of the roof.

The resulting material has been subjected to long-term impact of UV radiation and extreme environmental conditions (high and low temperatures), which has taken lighter elements out of the bitumen molecule and made it brittle. Theoretically, such waste could be used as an additive of asphalt concrete, but this is hindered by high variability of the material. Therefore, it is generally disposed in a landfill or combusted. Another problem is caused by inert additives contained in the residual material (fibrous material, sand, concrete pieces, etc.).

The method of the invention enables to manufacture weatherproof construction parts of such material, the properties of which are better compared to the original materials.

During processing, the bituminous materials and polyethylene are mixed and heated in the course of mixing for certain period of time. This way, bitumen is dispersed into nanoparticles, which are disposed between the polyethylene structure and linked to the latter. This results in a weatherproof, flexible, and non-flowing material.

### TECHNICAL PROBLEM

The main technical problem to be solved by the present invention is the fact that during renovation of roof, large quantities of waste bitumen-based roofing materials (BBRM) are generated, and until now, the possibilities for recycling these materials have been very limited. Generally, these materials can be shredded and mixed with asphalt for covering roads, or combusted in order to produce energy. Although plastic waste is often recycled, the melting process deteriorates essentially their durability and mechanical properties.

### TECHNICAL SOLUTION

Unlike regular methods, our recycling process results in a material, the properties of which are in various ways better than those of the original materials. It is durable, weatherproof, and with extremely high mechanical strength. This material can be used for manufacturing various construction parts, including for replacing fast-wearing wooden details in structures. The process is simple and it can be performed directly at the place of renovation, using a portable device.

The present invention provides a method for manufacturing construction parts from recycled residual bituminous material and recycled polyethylene.

The method comprises steps, where:
the residual bituminous material is cleaned of foreign substances (i.e. foreign bodies, metal, debris, etc.) and shredded into particles with the size of 5 to 50 mm,
the recycled polyethylene is shredded to the size of 5 to 50 mm,
the shredded residual bituminous material and shredded polyethylene are mixed in a heated mixer at 170° C. to 250° C. until a homogeneous mixture is obtained,
additives are added into the mixture, including stabilizers and fillers, and the mixture is allowed to react for 10 to 100 minutes,
construction parts are made from the resulting mixture by pressing or molding, and
the molded or pressed construction parts are allowed to cool down.

Suitable stabilizer is a substance promoting dispersion of the particles of the mixture, such as machine oil, magnesium oxide (MgO), or any other suitable stabilizer.

According to the invention, the residual bituminous material is a recycled roofing material containing bitumen.

According to the method, the mixture comprises 75 to 95 percent by weight of bitumen and 5 to 25 percent by weight of polyethylene.

The polyethylene is LDPE or HDPE or their mixture.

### ADVANTAGEOUS EFFECTS

The following advantages are achieved with the present invention.

Environmental friendliness: the present invention helps to minimize the amount of industrial waste, providing a possibility for recycling residual bitumen, roofing felt, and polyethylene.

Economic efficiency: the method enables to manufacture cheaper construction materials due to the use of recycled source materials with lower price. Companies can thus avoid gate fees of landfills.

Durability: the products are resistant to moisture, temperature fluctuations and chemical substances, which makes them suitable for various environmental conditions.

Broad usage possibilities: the manufactured construction parts are suitable for use in various construction projects, from road construction to covering of roof and walls of buildings.

The present invention provides an innovative and sustainable solution enabling to reuse residual bitumen, roofing felt, and polyethylene for manufacturing construction parts. This method enables to minimize the amount of waste, to manufacture high-quality construction materials, and to support environmentally sustainable development.

### DESCRIPTION OF EMBODIMENTS

The materials are first prepared with the method of the invention.

Residual bituminous materials (residual bitumen, BBRM) are collected, cleaned of foreign substances (including additives, such as metal, debris, foreign bodies) and shredded to the size suitable for melting, with diameter 5 to 50 mm.

The recycled polyethylene is washed, if necessary, and shredded to the size suitable for melting, e.g. into pieces of 5 to 50 mm.

Next, mixing of materials takes place.

The prepared residual bituminous material and polyethylene are mixed in a mechanical heated mixer at 170° C. to 250° C., until a homogeneous mixture is obtained. The base mixture is comprised of 75 to 95 percent by weight of bitumen, to which 5 to 25 percent by weight of polyethylene is added (both LDPE and HDPE can be used). Inert fillers, such as fibers, concrete waste, crushed stones, etc., can be added to the mixture for increasing mass and volume of the product up to 1000% of the mass of the composite mixture.

Then necessary additives are added, such as stabilizers or fillers, in order to improve the properties of the final product, and the mixture is allowed to react for 10 to 100 minutes.

After that, molding and processing is performed.

The mixture is pressed or molded into construction parts of desired shape, using suitable molds and processing technology (e.g. molding of continuous webbing with extruder).

The molded products are allowed to cool down, and additional processing, such as cutting or surface covering, is performed as necessary.

Example 1: The resulting liquid composite material is poured into molds, in order to create new construction parts (e.g. passageways). After solidification, these parts can be glued to necessary places with liquid bitumen.

Example 2: Liquid mixture from the processing machine is pressed through the extruder, in order to manufacture long construction parts, such as inclined surfaces of a roof. The resulting webbing is cut into pieces with required length and glued to the required places.

1. A method for manufacturing construction parts from recycled residual bituminous material and recycled polyethylene, characterized in that the method comprises steps, where
the residual bituminous material is a recycled roofing material containing bitumen,
the residual bituminous material is cleaned of foreign substances and shredded into particles with the size of 5 to 50 mm,
the recycled polyethylene is shredded to the size of 5 to 50 mm,
the shredded residual bituminous material and shredded polyethylene are mixed in a heated mixer at 170° C. to 250° C. until a homogeneous mixture is obtained,
additives are added into the mixture, including stabilizers and fillers, and the mixture is allowed to react for 10 to 100 minutes,
construction parts are made from the resulting mixture by pressing or molding, and
the molded or pressed construction parts are allowed to cool down.

2. The method according to claim 1, characterized in that the mixture comprises 75 to 95 percent by weight of bitumen and 5 to 25 percent by weight of polyethylene.

3. The method according to claim 1, characterized in that the polyethylene is LDPE, HDPE, or their mixture.
